(19) United States
(12) Patent Application Publication
(10) Pub. No.: US 2026/0084368 A1
(43) Pub. Date: Mar. 26, 2026

(54) UPPER MOLD DEVICE, PROCESSING APPARATUS HAVING THE SAME, AND PROCESSING METHOD

(71) Applicant: ALL RING TECH CO., LTD., Kaohsiung City (TW)

(72) Inventors: Tai-Hung LIU, Kaohsiung City (TW); Yan-Zuo CHEN, Kaohsiung City (TW); Chun-Hung TSAI, Kaohsiung City (TW)

(21) Appl. No.: 19/296,504

(22) Filed: Aug. 11, 2025

(30) Foreign Application Priority Data
Sep. 24, 2024 (TW) 113136227

(51) Int. Cl. B29C 51/36; B29C 51/10; B29C 51/12; B29C 51/30; B29L 31/34

(52) U.S. Cl. CPC B29C 51/36; B29C 51/10; B29C 51/12; B29C 51/303; B29L 2031/3406

(57) ABSTRACT

An upper mold device includes an upper mold mechanism, a gas storage unit adapted to store a processing gas, gas intake and exhaust units, and a negative pressure source. The upper mold mechanism includes a seal cover that is adapted to connected to and cooperate with a lower mold device to define a processing section therebetween, and gas inlet and outlet connectors that are mounted to the seal cover. The gas intake unit is in fluid communication with the gas storage unit and the gas inlet connector. The gas exhaust unit is in fluid communication with the gas outlet connector. The negative pressure source is in fluid communication with the gas exhaust unit, and extracts air that is in the processing section via the gas exhaust unit when activated, such that the processing gas flows into the processing section via the gas intake unit.

### CROSS-REFERENCE TO RELATED APPLICATION

This application claims priority to Taiwanese Invention patent application No. 113136227, filed on Sep. 24, 2024, the entire disclosure of which is incorporated by reference herein.

### FIELD

The disclosure relates to an upper mold device, a processing apparatus having the same and a processing method implemented by the processing apparatus, and more particularly to an upper mold device, a processing apparatus having the same and a processing method implemented by the processing apparatus for processing an integrated circuit component.

### BACKGROUND

Taiwanese Invention U.S. Pat. No. 1,568,324 titled “Method and Apparatus for Placement of Heat Sink” discloses a conventional packaging apparatus and a packaging method for packaging integrated circuit components. Before placement of a heat sink (also known as a lid) on a chip of an integrated circuit component provided on a substrate, a first adhesive is applied on the substrate adjacent to each of four corners of the chip, such that the first glues surround the chip and are provided for a peripheral depressed portion of a heat sink to be adhered thereto. Then, a second glue is applied on the chip for a central protruding portion of the heat sink to be adhered thereto. Subsequently, after the heat sink is placed on the chip, the substrate on which the heat sink is disposed is pressed. Taiwanese Invention U.S. Pat. No. 1,688,018 titled “Method and Device for Bonding a Heat Dissipation Pad” discloses another conventional packaging apparatus and packaging method for packaging integrated circuit components, in which a heat dissipation pad is provided to replace the second adhesive used in the conventional packaging apparatus and the heat dissipation pad is adhered on an upper surface of the chip.

Generally, the heat sink is usually made of metal materials such as copper, which is liable to be oxidized. Since the heat sink and the chip are connected by a thermal interface material such as adhesives or heat dissipation pads that are provided for heat transfer, oxidization of the heat sink may decrease connection strength between a lower surface of the heat sink and the chip, which in turn adversely affects quality of packaging of the integrated circuit components.

### SUMMARY

Therefore, an object of the present disclosure is to provide an upper mold device, a processing apparatus having the same, and a processing method that can alleviate at least one of the drawbacks of the prior art.

According to an aspect of the disclosure, an upper mold device is adapted to apply a pressure to an integrated circuit component in cooperation with a lower mold device, and is adapted to be used with a processing gas. The upper mold device includes an upper mold mechanism, a gas storage unit, at least one gas intake unit, at least one gas exhaust unit, and a negative pressure source. The upper mold mechanism includes a seal cover, and at least one gas outlet connector and at least one gas inlet connector that are mounted to the seal cover. The seal cover is adapted to be connected to and cooperate with the lower mold device to define a processing section therebetween. The gas storage unit is adapted to store the processing gas therein. The at least one gas intake unit is in fluid communication with the gas storage unit and the at least one gas inlet connector. The at least one gas exhaust unit is in fluid communication with the at least one gas outlet connector. The negative pressure source is in fluid communication with the at least one gas exhaust unit, and extracts air that is in the processing section via the at least one gas exhaust unit when activated, such that the processing gas in the gas storage unit flows into the processing section via the at least one gas intake unit.

According to another aspect of the disclosure, a processing apparatus adapted to process the integrated circuit component is provided. The processing apparatus includes a lower mold device adapted for carrying the integrated circuit component thereon, and the upper mold device described above operable to be connected to and cooperate with the lower mold device to define the processing section in which the integrated circuit component is processed.

According to still another aspect of the disclosure, a processing method includes:
placing, on a lower mold device, an integrated circuit component that includes a substrate, a chip disposed on the substrate, a thermal interface material disposed on the chip, and an upper lid disposed on the thermal interface material;
defining a processing section by connecting an upper mold device to the lower mold device for processing the integrated circuit component therein;
with a negative pressure source, extracting gas that is in the processing section, such that a processing gas flows into the processing section and performs a redox reaction with the upper lid of the integrated circuit component so as to reduce an oxidation state of the upper lid; and
applying a pressure to the upper lid with the upper mold device.

According to still another aspect of the disclosure, a processing method, includes:
placing, on a lower mold device, an integrated circuit component that includes a substrate, a chip disposed on the substrate, a thermal interface material disposed on the chip, and an upper lid disposed on the thermal interface material;
defining a processing section by connecting an upper mold device to the lower mold device for processing the integrated circuit component therein;
with a negative pressure source, extracting gas that is in the processing section, such that a processing gas flows into the processing section and reduces oxidation of the upper lid; and
applying a pressure to the upper lid with the upper mold device.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of an integrated circuit component including a chip and a substrate to be processed by an embodiment of a processing apparatus according to the present disclosure.

FIG. 2 is an exploded perspective view illustrating the integrated circuit component.

FIG. 3 is a perspective view of a processing apparatus of a first embodiment according to the present disclosure.

FIG. 4 is a fragmentary enlarged view of FIG. 3, illustrating the first embodiment.

FIG. 5 is a fragmentary schematic front view of the first embodiment, illustrating that the integrated circuit component is disposed on a lower mold device of the processing apparatus.

FIG. 6 is a fragmentary schematic front view similar to FIG. 5, but illustrating the integrated circuit component being pressed by an upper mold device of the processing apparatus.

FIG. 7 is a fragmentary schematic side view illustrating that a processing section is defined between the upper mold device and the lower mold device.

FIG. 8 is a fragmentary schematic view similar to FIG. 7, but illustrating that gas in the processing section is extracted and processing gas in a gas storage unit flows into the processing section.

FIG. 9 is a fragmentary schematic view of a processing apparatus of a second embodiment according to the present disclosure, illustrating that a storage unit of the second embodiment is modified.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

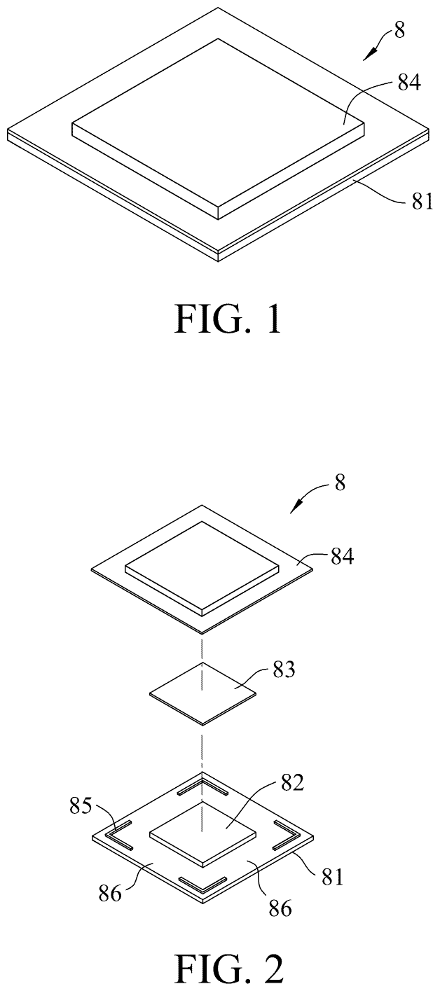

Referring to FIGS. 1 to 3, and 7, a first embodiment of a processing apparatus 100 according to the present disclosure is for processing an integrated circuit component 8 and is adapted to be used with a processing gas 92. As shown in FIG. 2, the integrated circuit component 8 includes a substrate 81, a chip 82 disposed on a central portion of the substrate 81, a thermal interface material 83 adhered on top of the chip 82, an adhesive 85 applied on four corners of the substrate 81, and an upper lid 84 placed on both of the chip 82 and the substrate 81.

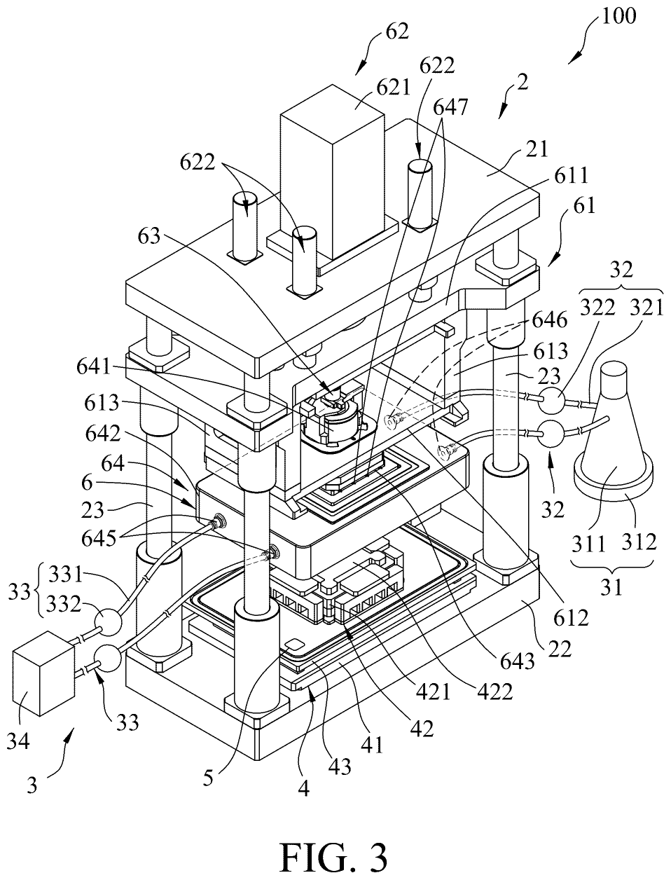

A peripheral depressed portion of the upper lid 84 is adhered to the substrate 81 at a lower surface of the upper lid 84 by the adhesive 85. A central protruding portion of the upper lid 84 is adhered to the chip 82 at the lower surface of the upper lid 84 by the thermal interface material 83 and dissipates thermal energy generated by the chip 82. The thermal interface material 83 is made of a material containing metal and is configured as a film. In one embodiment, the thermal interface material is made of indium (In), but the present disclosure is not limited herein. The upper lid 84 is also made of a material containing metal and is, e.g., a heat sink. In one embodiment, the upper lid is made of copper (Cu), but the present disclosure is not limited hereto. In the first embodiment, the processing gas 92 is formed by vaporization of a redox liquid 91, and the redox liquid 91 is, e.g., acetic acid, but the present disclosure is not limited herein. As shown in FIG. 3, the processing apparatus 100 includes a seat mechanism 2, an upper mold device 3, a lower mold device 4, and a detector 5.

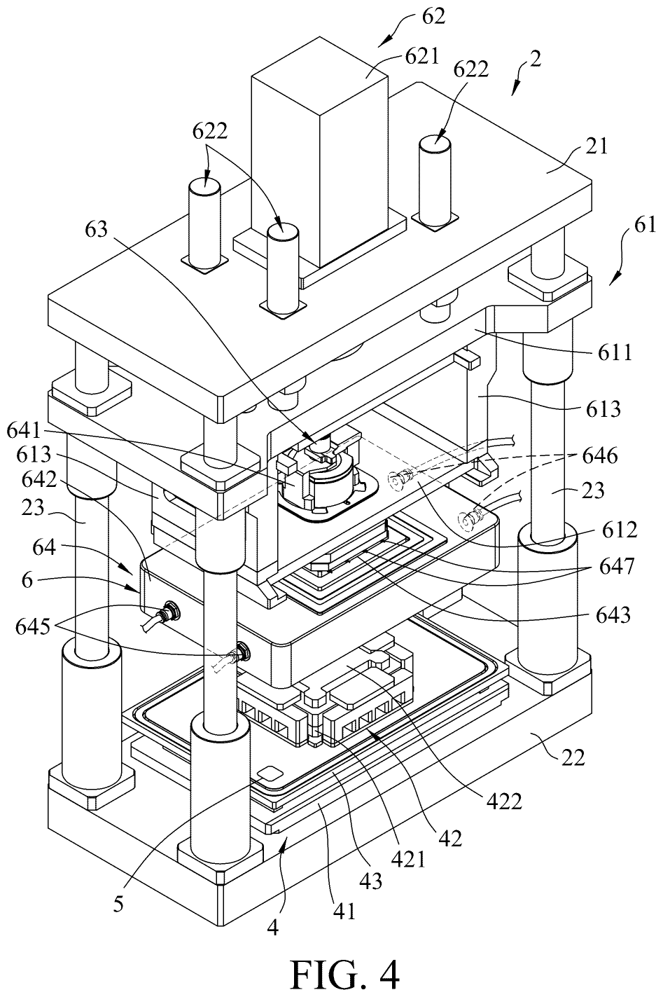

Further referring to FIGS. 4, 5 and 7, the seat mechanism 2 includes a top seat 21 and a base seat 22 spaced apart from each other in an up-down direction, and four posts 23 extending vertically between the top seat 21 and the base seat 22 and respectively located at four corners of the seat mechanism 2.

The upper mold device 3 includes an upper mold mechanism 6, a gas storage unit 31, two gas intake units 32, two gas exhaust units 33, and a negative pressure source 34.

The upper mold mechanism 6 includes a carrier seat unit 61 mounted to the seat mechanism 2, a first driving unit 62 mounted to the seat mechanism 2, a second driving unit 63 mounted to the carrier seat unit 61, and an upper mold unit 64 mounted to the carrier seat unit 61.

The carrier seat unit 61 includes an upper seat 611 that is mounted to the four posts 23 and that is movable relative to the posts 23 in the up-down direction, a lower seat 612 that is spaced apart from and disposed under the upper seat 611 in the up-down direction, and two connecting seats 613 that are spaced apart from each other in a left-right direction transverse to the up-down direction and that are connected between the upper seat 611 and the lower seat 612 in the up-down direction.

The first driving unit 62 extends through the top seat 21 in the up-down direction, and includes a first driving member 621 mounted above the upper seat 611 and driving movement of the carrier seat unit 61 in the up-down direction, and four guide rod mechanisms 622 protruding vertically and upwardly from the top seat 21. Each of the guide rod mechanisms 622 includes a guide rod 6220 connected fixedly to an upper surface of the upper seat 611, and operable to be co-movable with the upper seat 611, and a rod cover 6221 removably sleeved on the guide rod 6220.

The second driving unit 63 includes a second driving member 631 disposed under the upper seat 611, and a driving rod 632 driven by the second driving member 631 to move downwardly so as to press the upper mold unit 64 and thus apply a pressure to the integrated circuit component 8. In this embodiment, a travel distance of movement of the second driving member 631 is smaller than a travel distance of movement of the first driving member 621.

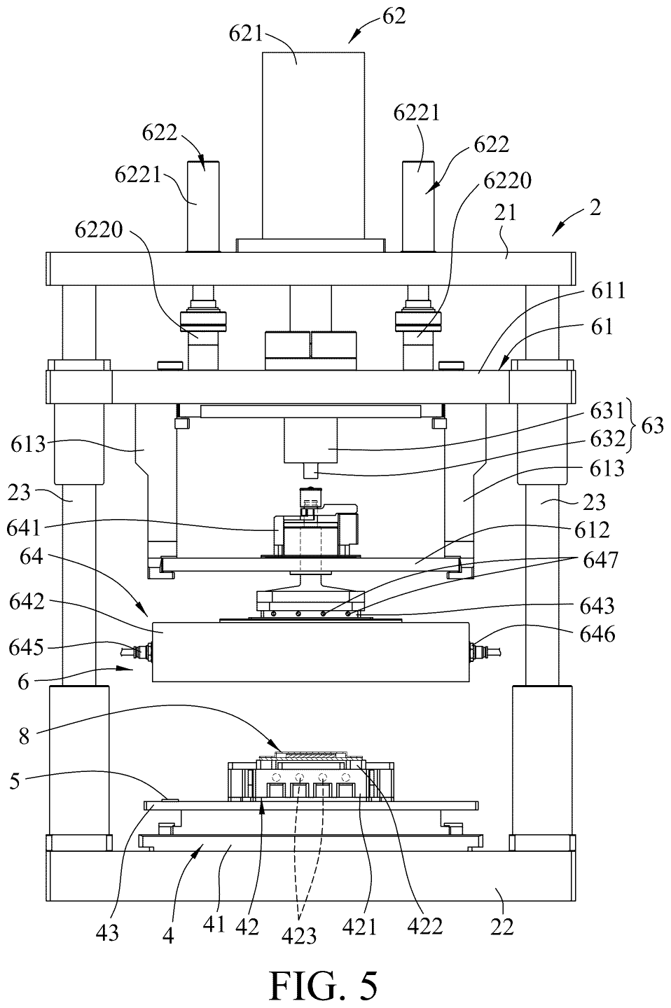

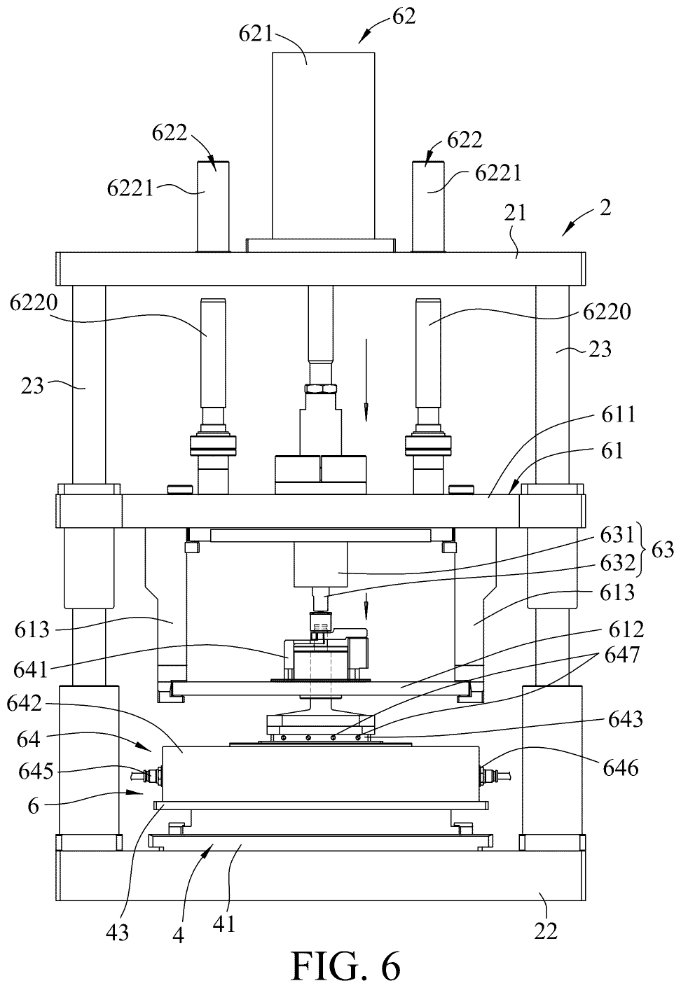

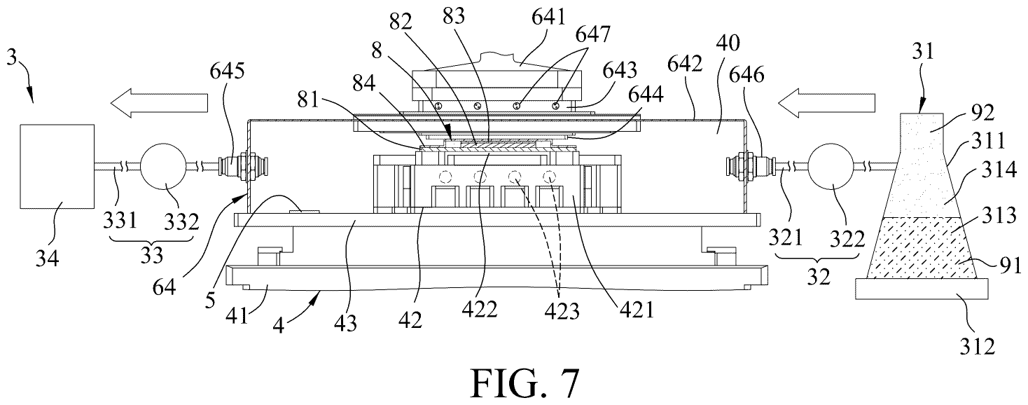

The upper mold unit 64 includes a pressing rod mechanism 641 that extends through the lower seat 612 in the up-down direction, a seal cover 642 that opens downwardly and that has an upper through hole (not shown) formed through the seal cover 642 in the up-down direction, a first heating seat 643 that is disposed under the pressing rod mechanism 641 and that is mounted to the upper through hole, an upper pressing mold 644 (see FIG. 7) that is disposed under the first heating seat 643 and that is disposed in the seal cover 642, two gas outlet connectors 645 (only one is visible in FIGS. 5 to 7), and two gas inlet connectors 646 (only one is visible in FIGS. 5 to 7). The gas outlet connectors 645 and the gas inlet connectors 646 are mounted to two opposite sides of the seal cover 642. In this embodiment, the driving rod 632 of the second driving unit 63 of the upper mold mechanism 6 of the upper mold device 3 is driven by the second driving member 631 to move downwardly and press the pressing rod mechanism 641 and thus apply a pressure to the upper lid 84 (see FIG. 2) of the integrated circuit component 8 to fixedly attach the upper lid 84 to the chip 82.

The first heating seat 643 includes a plurality of first heating members 647 extending in a front-rear direction that is transverse to the up-down direction and the left-right direction, and that are spaced apart from each other in the left-right direction. The first heating members 647 are operable to generate heat such that heat is conducted to the upper pressing mold 644 so the upper pressing mold 644 is heated to a first predetermined pressing temperature.

In the first embodiment, as depicted in FIG. 3, the gas outlet connectors 645 are disposed side by side at a left side of the seal cover 642, and the gas inlet connectors 646 are disposed side by side at a right side of the seal cover 642. It should be noted that in other embodiments, as long as air in the seal cover 642 may be extracted via the gas outlet connectors 645 and the processing gas 92 may flow into the seal cover 642 via the gas inlet connectors 646, positions of the gas outlet connectors 645 and the gas inlet connectors 646 may be modified, e.g., the gas outlet connectors 645 and the gas inlet connectors 646 may be mounted to two adjacent sides of the seal cover 642, and the present disclosure is not limited thereto. In addition, the numbers of the gas outlet connectors 645 and the gas inlet connectors 646 are two in this embodiment, but may be one or more than two in other embodiments.

As shown in FIGS. 3 and 7, the gas storage unit 31 includes a container 311, and a heater 312 disposed under the container 311 and operable to heat up the container 311.

The container 311 has a liquid accommodation region 313 disposed at a bottom portion of the container 311, and a gas accommodation region 314 disposed above the liquid accommodation region 313. The liquid accommodation region 313 is adapted for accommodating the redox liquid 91 therein. The gas accommodation region 314 is adapted for accommodating the processing gas 92 that is formed by vaporization of the redox liquid 91 when the redox liquid 91 in the container 311 is heated by the heater 312. Specifically, in this embodiment, the container 311 is a filter flask that has a narrow upper portion and a wide lower portion.

When the heater 312 heats up the container 311, the redox liquid 91 in the container 311 is vaporized to form the processing gas 92 having a temperature higher than room temperature to meet a temperature requirement during processing the integrated circuit component 8. It should be noted that the temperature of the processing gas 92 that is vaporized may range from 90° C. to 120° C., and is 100° C. in this embodiment.

The gas intake units 32 are in fluid communication respectively with the gas inlet connectors 646, and are in fluid communication with the gas accommodation region 314 of the container 311. Each of the gas intake units 32 includes a gas intake duct 321 in fluid communication with the container 311 of the gas storage unit 31 and the respective one of the gas inlet connectors 646, and a gas intake valve 322 mounted to the gas intake duct 321 and operable to adjust an amount of the processing gas 92 flowing into the seal cover 642.

The gas exhaust units 33 are in fluid communication respectively with the gas outlet connectors 645 and are in fluid communication with the negative pressure source 34. Each of the gas exhaust units 33 includes a gas exhaust tube 331 in fluid communication with the respective one of the gas outlet connectors 645 and the negative pressure source 34, and a gas exhaust valve 332 mounted to the gas exhaust tube 331 and operable to adjust an amount of air being extracted out of the seal cover 642.

Referring to FIGS. 4, 5 and 8, the lower mold device 4 is adapted for carrying the integrated circuit component 8 thereon, and includes a carrier unit 41 disposed on the base seat 22 of the seat mechanism 2, a lower pressing mold unit 42 disposed on the carrier unit 41, and a lower cover unit 43 surrounding the carrier unit 41 and configured as a frame.

The lower pressing mold unit 42 includes a second heating seat 421 disposed on the carrier unit 41, and a lower pressing mold 422 disposed on a top surface of the second heating seat 421. The second heating seat 421 includes a plurality of second heating members 423 extending in the front-rear direction and disposed to be spaced apart from each other in the left-right direction. The second heating members 423 are operable to generate heat such that heat is conducted to the lower pressing mold 422 so the lower pressing mold 422 is heated to a second predetermined pressing temperature.

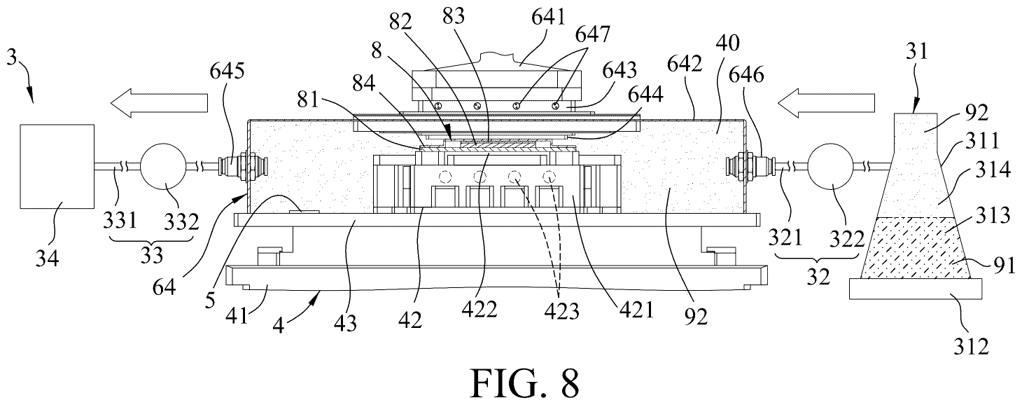

The lower cover unit 43 supports the seal cover 642 of the upper mold mechanism 6 thereon and cooperates therewith to define a processing section 40 (FIG. 8) therebetween. The negative pressure source 34 extracts air that is in the processing section 40 via the gas exhaust units 33 when activated, such that the processing gas 92 in the gas storage unit 31 flows into the processing section 40 via the gas intake units 32.

The detector 5 is disposed on the carrier unit 41, and is adapted to detect a concentration of the processing gas 92 in the processing section 40. In the first embodiment, the detector 5 detects a pH value of the processing gas 92 to obtain the concentration of the processing gas 92. In this embodiment, the detector 5 is mounted to the carrier unit 41, but is not limited hereto. It should be noted that the detector 5 may be mounted to the seal cover 642 of the upper mold device 3 as long as the concentration of the processing gas 92 in the processing section 40 may be detected thereby.

Referring to FIGS. 5 to 7, a processing method performed by the processing apparatus 100 of the present disclosure is described below and includes the following steps.

The integrated circuit component 8 is placed on the lower pressing mold 422 of the lower mold device 4 with the substrate 81 in contact with the lower pressing mold 422.

The upper mold device 3 and the lower mold device 4 are connected to cooperatively define the processing section 40 in which the integrated circuit component 8 is processed. Specifically, the first driving member 621 of the first driving unit 62 drives the carrier seat unit 61 to move downwardly relative to the posts 23 in the up-down direction such that the seal cover 642 of the upper mold unit 64 covers the lower cover unit 43 of the lower mold device 4 to define the processing section 40 therebetween (see FIG. 8).

The negative pressure source 34 extracts gas that is in the processing section 40 via the gas exhaust units 33, such that the processing gas 92 flows into the processing section 40 via the gas intake units 32 and performs a redox reaction with the upper lid 84 of the integrated circuit component 8 so as to reduce an oxidation state of the upper lid 84.

The detector 5 continuously detects a concentration of the processing gas 92 in the processing section 40. It should be noted that, after the processing gas 92 flows into and fills the processing section 40, the negative pressure source 34 stops extracting gas that is in the processing section 40 so the processing gas 92 is retained in the processing section 40. In one embodiment, when the concentration of the processing gas 92 in the processing section 40 reaches a predetermined upper limit, the negative pressure source 34 stops extracting gas that is in the processing section 40 so the processing gas 92 is retained in the processing section 40.

The upper lid 84 of the integrated circuit component 8 is made of a material including copper, so an oxide layer formed on the upper lid 84 is copper oxide and is processed by the processing gas 92 to perform a reduction reaction. Thus, the oxide layer, i.e., copper oxide, is reduced to copper. It should be noted that although the peripheral depressed portion of the upper lid 84 is adhered to the substrate 81, since the adhesive 85 is only applied on the four corners of the substrate 81, the processing gas 92 may flow into the integrated circuit component 8 through a plurality of gaps 86 (see FIG. 2) that are formed between the upper lid 84 and the substrate 81 to thereby perform a redox reaction with the lower surface of the upper lid 84 so as to reduce an oxidation state of the upper lid 84.

The upper pressing mold 644 is heated by the first heating members 647 to the first predetermined pressing temperature, and the lower pressing mold 422 is heated by the second heating members 423 to the second predetermined pressing temperature. Hence, the upper pressing mold 644 heated to the first predetermined pressing temperature melts the thermal interface material 83, and the lower pressing mold 422 heated to the second predetermined pressing temperature softens the substrate 81.

The second driving member 631 of the second driving unit 63 of the upper mold device 3 drives the driving rod 632 to move downwardly and press the pressing rod mechanism 641, so the upper pressing mold 644 of the upper mold device 3 that is disposed under the pressing rod mechanism 641 applies a pressure to the upper lid 84 of the integrated circuit component 8 to fixedly attach the upper lid 84 to the chip 82. In this embodiment, the first heating members 647 heat up the upper pressing mold 644 so the upper lid 84 is heated by the upper pressing mold 644, and the second heating members 423 heat up the lower pressing mold 422 so the substrate 81 of the integrated circuit component 8 is heated by the lower pressing mold 422. It should be noted that either one of or both of the upper pressing mold 644 and the lower pressing mold 422 may be heated as required.

Hereafter, the gas intake valve 322 of each of the gas intake units 32 is closed, and the negative pressure source 34 is activated to extract gas, i.e., the processing gas 92, retained in the processing section 40. In this way, the processing gas 92 in the gas storage unit 31 is prevented from flowing into the processing section 40. When the detector 5 detects that the concentration of the processing gas 92 in the processing section 40 is zero or lower than a predetermined lower limit, the upper mold device 3 is separated from the lower mold device 4 so processing and packaging of the integrated circuit component 8 is completed.

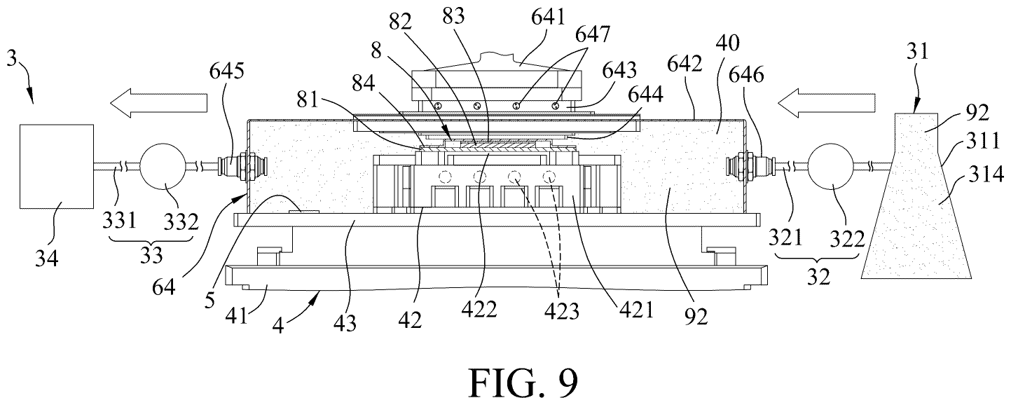

Referring to FIG. 9, a second embodiment of a processing apparatus 100 according to the present disclosure is similar to the first embodiment, and the differences therebetween reside in the following. In the second embodiment, the gas storage unit 31 only includes the container 311, and the heater 312 shown in FIGS. 7 to 9 is omitted. In this embodiment, the container 311 only has the gas accommodation region 314 and the processing gas 92 is nitrogen gas (N₂).

Since the integrated circuit component 8 is subjected to a high temperature in the processing section 40, the upper lid 84 of the integrated circuit component 8 is liable to be oxidized and form an oxide layer thereon. In the second embodiment, by virtue of introducing the processing gas 92, i.e., the nitrogen gas, into the processing section 40 to replace air in the processing section 40, formation of the oxide layer on the upper lid 84 may be reduced. That is to say, the processing gas reduces oxidation of the upper lid 84 of the integrated circuit component 8.

In summary, by virtue of the design of the negative pressure source 34 that extracts air that is in the processing section 40 and that introduces the processing gas 92 in the gas storage unit 31 into the processing section 40, the processing gas 92 reduces formation of the oxidation layer of the upper lid 84 of the integrated circuit component 8 or performs a redox reaction to the oxidation layer that has been formed on the upper lid 84, thereby increasing a connection strength between the lower surface of the upper lid 84 and an upper surface of the chip 82 so a quality of packaging of the integrated circuit component 8 may be improved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An upper mold device adapted to apply a pressure to an integrated circuit component in cooperation with a lower mold device, and adapted to be used with a processing gas, said upper mold device comprising:
an upper mold mechanism including a seal cover, and at least one gas outlet connector and at least one gas inlet connector that are mounted to said seal cover, said seal cover adapted to be connected to and cooperate with the lower mold device to define a processing section therebetween;
a gas storage unit adapted to store the processing gas therein;
at least one gas intake unit in fluid communication with said gas storage unit and said at least one gas inlet connector;
at least one gas exhaust unit in fluid communication with said at least one gas outlet connector; and
a negative pressure source in fluid communication with said at least one gas exhaust unit, and extracting air that is in said processing section via said at least one gas exhaust unit when activated, such that the processing gas in said gas storage unit flows into said processing section via said at least one gas intake unit.

2. The upper mold device as claimed in claim 1, wherein said at least one gas exhaust unit includes:
a gas exhaust tube in fluid communication with said negative pressure source and said at least one gas outlet connector; and
a gas exhaust valve mounted to said gas exhaust tube and operable to adjust an amount of air being extracted out of said processing section.

3. The upper mold device as claimed in claim 1, wherein said at least one gas intake unit includes:
a gas intake duct in fluid communication with said gas storage unit and said at least one gas inlet connector; and
a gas intake valve mounted to said gas intake duct and operable to adjust an amount of the processing gas flowing into said processing section.

4. The upper mold device as claimed in claim 1, wherein said at least one gas outlet connector and said at least one gas inlet connector are respectively mounted to two opposite sides of said seal cover.

5. The upper mold device as claimed in claim 4, wherein:
said at least one gas intake unit includes a plurality of gas intake units;
said at least one gas exhaust unit includes a plurality of gas exhaust units;
said at least one gas outlet connector includes a plurality of gas outlet connectors disposed side by side at one of said two opposite sides of said seal cover, and respectively in fluid communication with said plurality of gas exhaust units;
said at least one gas inlet connector includes a plurality of gas inlet connectors disposed side by side at another one of said two opposite sides of said seal cover, and respectively in fluid communication with said plurality of gas intake units.

6. The upper mold device as claimed in claim 1, the processing gas being formed by vaporization of a redox liquid, wherein:
said gas storage unit includes a container that has
a liquid accommodation region disposed at a bottom portion of said container and adapted for accommodating the redox liquid therein, and
a gas accommodation region disposed above said liquid accommodation region, in fluid communication with said at least one gas intake unit, and adapted for accommodating the processing gas therein.

7. The upper mold device as claimed in claim 1, the processing gas being formed by vaporization of a redox liquid, wherein:
said gas storage unit includes
a container adapted for accommodating the redox liquid therein; and
a heater disposed under and operable to heat up said container such that the redox liquid in said container is vaporized to form the processing gas having a temperature higher than room temperature.

8. A processing method comprising:
placing, on a lower mold device, an integrated circuit component that includes a substrate, a chip disposed on the substrate, a thermal interface material disposed on the chip, and an upper lid disposed on the thermal interface material;
defining a processing section by connecting an upper mold device to the lower mold device for processing the integrated circuit component therein;
with a negative pressure source, extracting gas that is in the processing section, such that a processing gas flows into the processing section and performs a redox reaction with the upper lid of the integrated circuit component so as to reduce an oxidation state of the upper lid; and
applying a pressure to the upper lid with the upper mold device.

9. The processing method as claimed in claim 8, wherein:
the processing method further comprises, after the processing gas flows into and fills the processing section, stopping extraction of gas that is in the processing section by the negative pressure source so the processing gas is retained in the processing section.

10. The processing method as claimed in claim 9, wherein:
the processing method further comprises one of heating up the upper lid with the upper mold device, heating up the substrate with the lower mold device, and a combination thereof when the upper mold device applies a pressure to the upper lid.

11. The processing method as claimed in claim 9, wherein:
the processing method further comprises
with the negative pressure source, extracting the processing gas retained in the processing section after the upper mold device applies a pressure to the upper lid, and
separating the upper mold device from the lower mold device.

12. A processing method, comprising:
placing, on a lower mold device, an integrated circuit component that includes a substrate, a chip disposed on the substrate, a thermal interface material disposed on the chip, and an upper lid disposed on the thermal interface material;
defining a processing section by connecting an upper mold device to the lower mold device for processing the integrated circuit component therein;
with a negative pressure source, extracting gas that is in the processing section, such that a processing gas flows into the processing section and reduces oxidation of the upper lid; and
applying a pressure to the upper lid with the upper mold device.

13. A processing apparatus adapted to process the integrated circuit component, said processing apparatus comprising:
a lower mold device adapted for carrying the integrated circuit component thereon; and
said upper mold device as claimed in claim 1 operable to be connected to and cooperate with said lower mold device to define said processing section in which the integrated circuit component is processed.

14. The processing apparatus as claimed in claim 13, wherein:
said processing apparatus further comprises a detector mounted to one of said lower mold device and said upper mold device, and adapted to detect a concentration of the processing gas in said processing section.

15. The processing apparatus as claimed in claim 13, wherein said at least one gas exhaust unit includes:
a gas exhaust tube in fluid communication with said negative pressure source and said at least one gas outlet connector; and
a gas exhaust valve mounted to said gas exhaust tube and operable to adjust an amount of air being extracted out of said processing section.

16. The processing apparatus as claimed in claim 13, wherein said at least one gas intake unit includes:
a gas intake duct in fluid communication with said gas storage unit and said at least one gas inlet connector; and
a gas intake valve mounted to said gas intake duct and operable to adjust an amount of the processing gas flowing into said processing section.

17. The processing apparatus as claimed in claim 13, wherein said at least one gas outlet connector and said at least one gas inlet connector are respectively mounted to two opposite sides of said seal cover.

18. The processing apparatus as claimed in claim 17, wherein:
said at least one gas intake unit includes a plurality of gas intake units;
said at least one gas exhaust unit includes a plurality of gas exhaust units;
said at least one gas outlet connector includes a plurality of gas outlet connectors disposed side by side at one of said two opposite sides of said seal cover, and respectively in fluid communication with said plurality of gas exhaust units;
said at least one gas inlet connector includes a plurality of gas inlet connectors disposed side by side at another one of said two opposite sides of said seal cover, and respectively in fluid communication with said plurality of gas intake units.

19. The processing apparatus as claimed in claim 13, the processing gas being formed by vaporization of a redox liquid, wherein:
said gas storage unit includes a container that has
a liquid accommodation region disposed at a bottom portion of said container and adapted for accommodating the redox liquid therein, and
a gas accommodation region disposed above said liquid accommodation region, in fluid communication with said at least one gas intake unit, and adapted for accommodating the processing gas therein.

20. The processing apparatus as claimed in claim 13, the processing gas being formed by vaporization of a redox liquid, wherein:
said gas storage unit includes
a container adapted for accommodating the redox liquid therein; and
a heater operable to heat up said container such that the redox liquid in said container is vaporized to form the processing gas having a temperature higher than room temperature.
